(19) United States
(12) Patent Application Publication
(10) Pub. No.: US 2016/0046007 A1
(43) Pub. Date: Feb. 18, 2016

(54) APPARATUS AND METHOD FOR SQUARING A PISTON RING

(71) Applicant: Richard L. Touchette, Mooresville, NC (US)

(72) Inventor: Richard L. Touchette, Mooresville, NC (US)

(21) Appl. No.: 14/824,725

(22) Filed: Aug. 12, 2015

Related U.S. Application Data
(60) Provisional application No. 62/036,411, filed on Aug. 12, 2014.

(51) Int. Cl. B25B 27/12

(52) U.S. Cl. CPC B25B 27/12

(57) ABSTRACT

An apparatus is provided for squaring a piston ring for fitting within a cylinder bore of a combustion engine. The piston ring squaring apparatus comprises a body including a first body portion and a second body portion. The second body portion is pivotally connected at one end to an end of the first body portion. Means are provided for biasing the first body portion away from the second body portion. The piston ring squaring apparatus allows the piston ring to be squared and supported when the piston ring is in the cylinder bore being measure for ring end gap.

### CROSS-REFERENCES

This application is related to U.S. provisional application No. 62/036,411, filed Aug. 12, 2014, entitled “POSITIVE SUPPORTIVE RING SQUARING TOOL”, naming Richard L. Touchette as the inventor. The contents of the provisional application are incorporated herein by reference in their entirety, and the benefit of the filing date of the provisional application is hereby claimed for all purposes that are legally served by such claim for the benefit of the filing date.

### BACKGROUND

An apparatus and method for squaring a piston ring is provided for squaring and end cap setting of the piston ring in a cylinder bore of a combustion engine and, more particularly, a piston ring squaring apparatus and method which provides active support to piston ring.

Conventionally, custom piston ring end gap filling and fitting is performed with piston ring squaring tools that will square the piston ring in the bore to be measured. The piston ring tool is then removed to perform the piston ring end gap measurement. However, because the piston ring tool does not retain the ring in a square position while the process of gap measurement is being performed, the piston ring being gapped may deflect. Therefore, it is necessary to continue to re-square the piston ring in the bore several times during the checking and measuring of the gap. In addition, each cylinder bore size requires a different, appropriate piston ring squaring tool.

For the foregoing reasons, there is a need for a new piston ring squaring apparatus and method that maintains the squaring of the piston ring while end gapping of the piston rings is performed. The piston ring squaring apparatus and method should require a single placement into the cylinder bore for squaring and supporting the piston ring. Ideally, the piston ring squaring apparatus is self-adjusting and self-aligning to multiple bore sizes.

### SUMMARY

An apparatus is provided for squaring a piston ring for fitting within a cylinder bore of a combustion engine. The piston ring squaring apparatus comprises a body including a first body portion and a second body portion. The second body portion is pivotally connected at one end to an end of the first body portion. Means are provided for biasing the first body portion away from the second body portion. The piston ring squaring apparatus allows the piston ring to be squared and supported when the piston ring is in the cylinder bore being measure for ring end gap.

### BRIEF DESCRIPTION OF THE DRAWINGS

For a more complete understanding of the piston ring squaring apparatus and method, reference should now be had to the embodiments shown in the accompanying drawings and described below. In the drawings:

FIG. 1 is a perspective view of an embodiment of an apparatus for squaring a piston ring for use in a combustion engine.

FIG. 2 is an exploded perspective view of the piston ring squaring apparatus as shown in FIG. 1.

FIG. 3 is a top plan view of the piston ring squaring apparatus as shown in FIG. 1 in a first position.

FIG. 4 is a top plan view of the piston ring squaring apparatus as shown in FIG. 3 in a second position.

FIG. 5 is a top plan view of the piston ring squaring apparatus as shown in FIG. 1 disposed in a cylinder bore.

FIG. 6 is a cross-section view of the piston ring squaring apparatus disposed in the cylinder bore as shown in FIG. 5 with an exploded piston ring.

FIG. 7 is a cross-section view of the piston ring squaring apparatus disposed in a cylinder bore with the piston ring with the piston ring apparatus in the second position.

FIG. 8 is a cross-section view of the piston ring squaring apparatus disposed in the cylinder bore and engaging the piston ring.

FIG. 9 is a top plan view of the piston ring squaring apparatus disposed in the cylinder bore and engaging the piston ring as shown in FIG. 8.

### DESCRIPTION

Certain terminology is used herein for convenience only and is not to be taken as a limiting. For example, words such as “upper,” “lower,” “left,” “right,” “horizontal,” “vertical,” “upward,” “downward,” “top” and “bottom” merely describe the configurations shown in the FIGs. Indeed, the components may be oriented in any direction and the terminology, therefore, should be understood as encompassing such variations unless specified otherwise. The words “interior” and “exterior” refer to directions toward and away from, respectively, the geometric center of the core and designated parts thereof. The terminology includes the words specifically mentioned above, derivatives thereof and words of similar import.

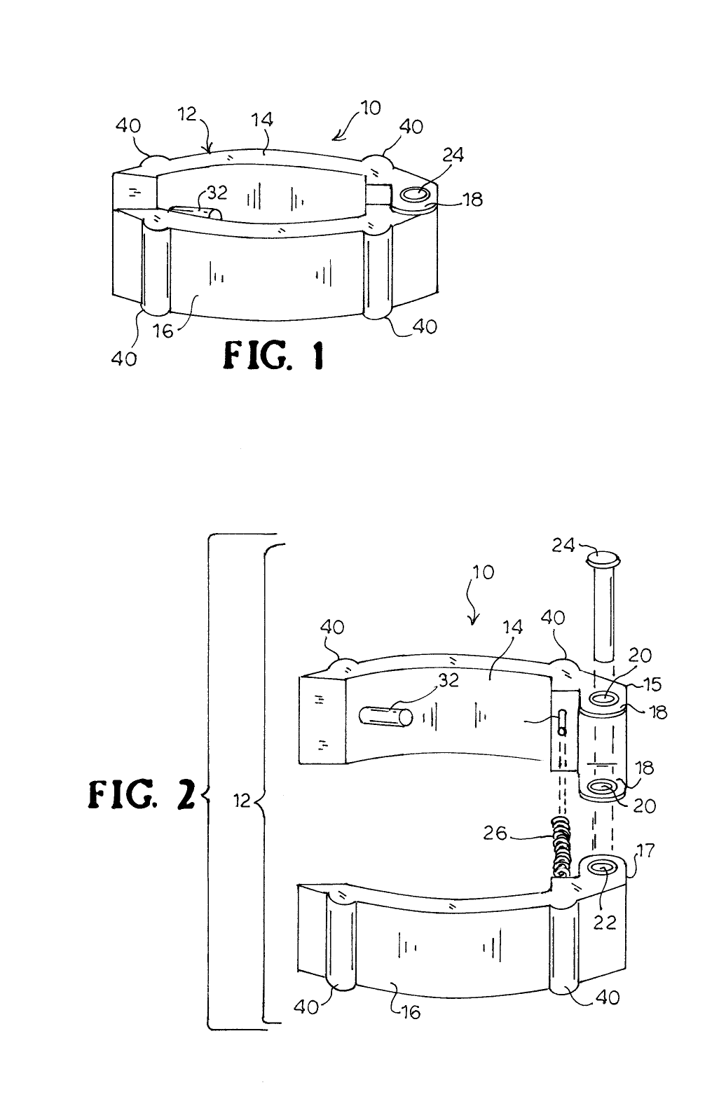

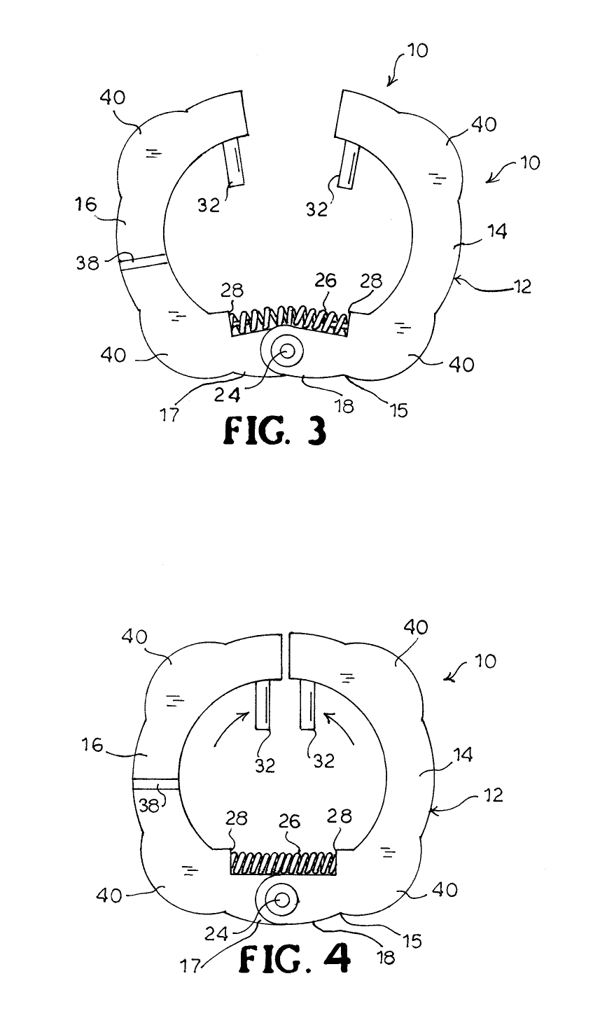

Referring now to the drawings, wherein like reference numerals designate corresponding or similar elements throughout the several views, an embodiment of an apparatus for squaring a piston ring is shown and generally designated at 10. The piston ring squaring apparatus, or tool 10, provides support to a piston ring for squaring in the cylinder bore without ring deflection or distortion while being measured and gapped. Referring to FIGS. 1-4, the piston ring squaring tool comprises a main body 12 including a first body portion 14 connected to a second body portion 16. Each body portion 14, 16 is generally C-shaped and is a mirror image of the other. The connected end 15 of the first body portion 14 includes a pair of parallel opposed ears 18 extending from the end. The ears 18 define aligned holes 20. The connected end 17 of the second body portion 16 defines a pass through opening 22. The first body portion 14 and the second body portion 16 are pivotally connected at their respective ends 15, 17 by a pin 24. The pin 24 extends through the holes 20 in the ears 18 on the first boy portion 14 and the pass through opening 22 in the end 17 of the second body portion 16. The pin 24 is sized such that the first body portion 14 and the second body portion 16 can pivot relative to one another about the pin 24.

The piston ring squaring tool 10 further comprises means for biasing apart the first body portion 14 and the second body portion 16. In one embodiment shown in the FIGs., the biasing means is a coil spring 26. The ends of the coil spring 26 contact opposed shoulders 28 on the first body portion 14 and the second body portion 16. A post 30 extends inwardly from each shoulder 28. The ends of the coil spring 26 receive the posts 30 for holding the coil spring 26 on the body 12 of the piston ring squaring tool 10 even when the spring is distorted. The coil spring 26 functions to force apart the first body portion 14 and the second body portion 16 allowing the body 12 to expand.

A finger grip 32 extends inwardly from each of the spaced ends of the first body portion 14 and the second body portion 16. The finger grips 32 allow the user to draw together the spaced ends of the first body portion 14 and the second body portion 14 against the force of the spring (FIG. 4).

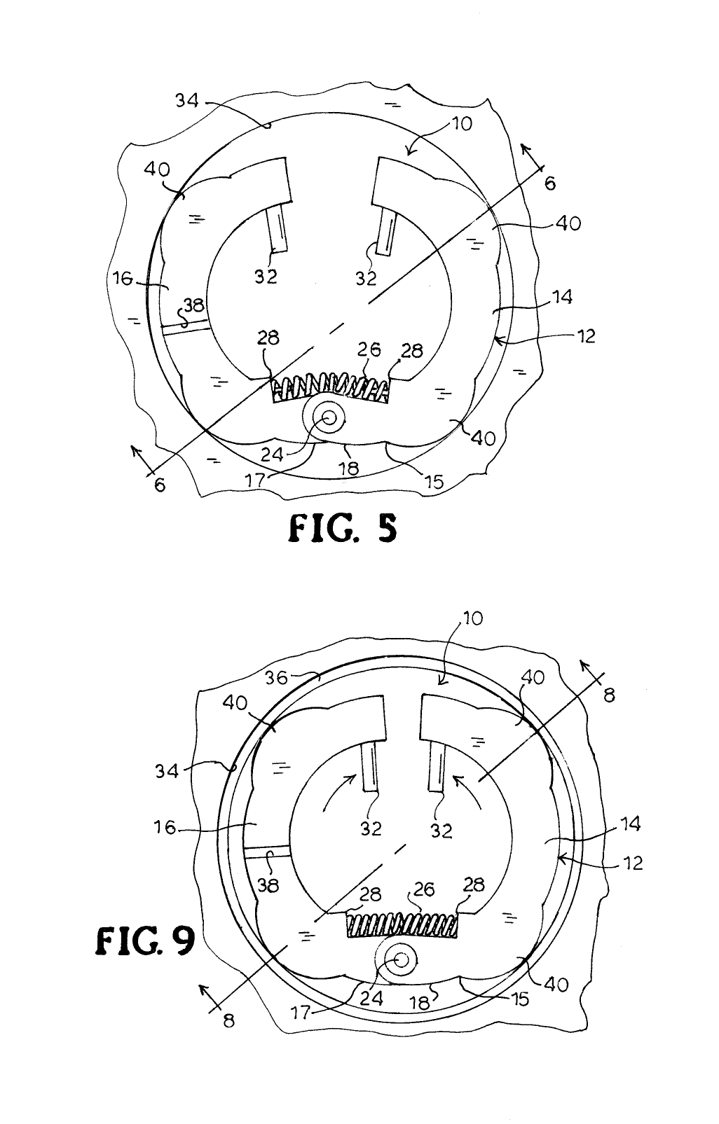

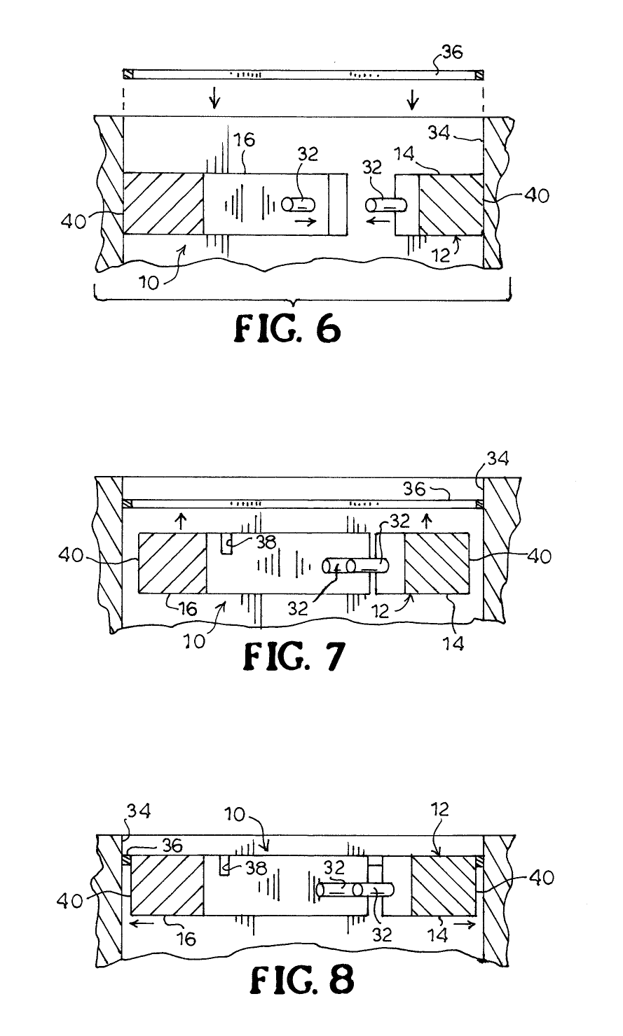

In use, the user engages the finger grips 32 and pulls together the spaced ends of the first body portion 14 and the second body portion 16 against the force of the spring 26. The user then places the compressed piston ring squaring tool 10 in a cylinder bore 34 of a combustion engine and releases the finger grips 32. This allows the spring 26 to bias the first body portion 14 and the second body portion 16 away from one another until the body 12 engages the cylinder bore 34 (FIG. 5). The perimeter of the body 12 includes two pairs of diametrically opposed protrusions 40 which engage the inner wall of the cylinder bore 34. A piston ring 36 is then placed in the cylinder bore 34 and the piston ring squaring tool 10 is compressed by the user (FIG. 6). The user them moves the compressed piston ring squaring tool 10 inside of the piston ring 36 (FIG. 7). The user releases finger grips 32 allowing the spring 26 to expand the body 12 until the protrusions 40 engage the piston ring 36 (FIG. 8). In this position, the piston ring squaring tool 10 positively supports the piston ring 34 for measuring the piston ring end gap while squaring the piston ring 34. The specific piston ring end gap may be accomplished without removing the piston ring squaring tool 10.

The piston ring squaring tool 10 has many advantages, including selective positioning, wherein the piston ring squaring tool 10 may be rotated to various radial positions accurately, consistently and repeatedly. Any number of positions of height and diameter within the cylinder bore range being measured are also possible due to the self-adjusting and aligning spring-loaded body 12. Moreover, the piston ring squaring tool 10 may be used with any cylinder bore size being measured for piston ring gapping preferences. The positive supportive piston ring squaring tool apparatus produces measurements without deflection and supports the piston ring in the cylinder bore while piston ring gapping. These measurements are repeatable and, therefore, more accurate piston ring gapping measurements within the cylinder bore can be obtained. A user may make changes to the piston ring end gap and re-measure with accuracy, streamlining the piston ring end gap process. This allows piston ring end measuring and gapping with accurate information.

Although the piston ring squaring tool has been shown and described in considerable detail with respect to only a few exemplary embodiments thereof, it should be understood by those skilled in the art that I do not intend to limit the tool to the embodiments since various modifications, omissions and additions may be made to the disclosed embodiments without materially departing from the novel teachings and advantages, particularly in light of the foregoing teachings. Accordingly, I intend to cover all such modifications, omission, additions and equivalents as may be included within the spirit and scope of the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

I claim:

1. An apparatus for squaring a piston ring for fitting within a cylinder bore of a combustion engine, the piston ring squaring apparatus comprising:
a body including
a first body portion, and
a second body portion, the second body portion pivotally connected at one end to an end of the first body portion; and
means for biasing the first body portion away from the second body portion.

2. The piston ring squaring apparatus as recited in claim 1, wherein the biasing means comprises a coil spring disposed between the first body portion and the second body portion.

3. The piston ring squaring apparatus as recited in claim 2, wherein each of the first body portion and the second body portion comprise a retaining post for retaining the coil spring on the body.

4. The piston ring squaring apparatus as recited in claim 1, wherein the body further comprises protrusions on the perimeter of the first body portion and the second body portion for engaging the walls of the cylinder bore or the piston ring.

5. The piston ring squaring apparatus as recited in claim 1, wherein each of the first body portion and the second body portion comprise a finger pin for moving the free ends of the first body portion and the second body portion together.
